(19) United States
(12) Patent Application Publication
(10) Pub. No.: US 2015/0224019 A1
(43) Pub. Date: Aug. 13, 2015

(54) HEADWEAR WITH INTEGRATED VIBRATORY ELEMENTS, AND A THERAPEUTIC METHOD OF USE

(71) Applicant: Comfort Solutions, LLC, Beaverton, OR (US)

(72) Inventor: Cruz Irene Barbera, Beaverton, OR (US)

(73) Assignee: Comfort Solutions, LLC, Beaverton, OR (US)

(21) Appl. No.: 14/175,064

(22) Filed: Feb. 7, 2014

(51) Int. Cl. A61H 23/02

(52) U.S. Cl. CPC A61H 23/02

(57) ABSTRACT

An item of headwear with a vibratory structure disposed within the headwear item, the vibratory structure including a first vibratory element, an actuation control, either or both of a power source and an operable retainer for a power source, and one or more electrically conductive lines operably coupling the first vibratory element, the actuation control, and either or both of the power source and the operable retainer for a power source. Additionally, a method for therapeutically applying vibration to the head of a human subject with Tourette syndrome, or alternatively a migraine headache, includes disposing upon the head of a human subject. a headwear item configured with an operable vibratory structure, and actuating the vibrator structure, upon the occurrence of, or anticipated occurrence of, one or more events having particular relevance to a human subject with Tourette syndrome or with a migraine headache.

### FIELD OF THE INVENTION

The invention relates generally to the field of head-wearable apparel items, devices and methods beneficial to individuals with Tourette syndrome, and sufferers of migraine headaches and other conditions. More particularly, the invention relates to the structure of a headwear device having discretely integrated, user-controllable vibratory structure, and a beneficial method of use.

### BACKGROUND OF THE INVENTION

It is well-known that Tourette syndrome causes those having the syndrome to exhibit sudden, brief, often repeated, movements or sounds, known respectively as physical (or ‘motor’) tics and vocal tics. Such tics are frequently preceded by an uncontrollable, internally perceived urge, referred to as a ‘premonitory urge.’ Individuals with Tourette syndrome commonly describe that a particular expressed tic feels like the ‘right’ action responsive to a particular premonitory urge, and what feels ‘right’ can vary from person to person, and from episode to episode.

Attempts to ignore a premonitory urge, and to suppress the expression of a tic, often result in the person expressing the tic to a greater extent—e.g., a more violently expressed gesture, or a more loudly shouted word., Further, the particular tics expressed by an individual with Tourette syndrome can change over time, and any particular episode may involve the expression of multiple distinct tics, such as combinations of physical tics, of vocal tics, or of both physical and vocal tics.

In some instances, the premonitory urge manifests as an inappropriate word or phrase forming in the person's mind, and the person can only find relief by audibly speaking the word. In public, social, employment, and other everyday settings, such vocal tics, and also numerous forms of physical tics, can be extremely disruptive, eliciting stares, disapproving looks, and even angry responses from surrounding persons.

Naturally, many individuals with Tourette syndrome feel shame and embarrassment, and even fear reprisal. Further, in the past, individuals with Tourette syndrome sometimes found themselves ejected from, or barred from, accessing and utilizing various public, and private settings and services, such as classrooms, public transportation, theaters, employment opportunities, etc. As a result, it is not uncommon for individuals with Tourette syndrome to take antidepressant medications, such as fluoxetine (Prozac, Sarafem, and others), to control symptoms of sadness, anxiety, or obsessive compulsive disorder.

There is no cure for Tourette syndrome, however, individuals with Tourette syndrome may find some relief, from some tics, via medications such as fluphenazine, haloperidol (Haldol), pimozide (Orap), or Botulinum toxin type A (Botox) injections. Not all treatments work for all individuals with Tourette syndrome, or to the same extent, and several such medications have undesirable side effects, such as weight gain, dulling of the mind, etc.

Other therapies can include psychotherapy or behavior therapy, and in severe cases can include extreme measures such as ‘deep brain stimulation,’ which involves implanting a battery-operated device into the individual's brain to deliver electrical impulses to portions of the brain that control movement. However, such medical interventions can be extremely expensive, and are not implementable by an individual with Tourette syndrome without the intervention of a trained professional.

Individuals that suffer from migraine headaches also contend with often chronic, severe, unrelenting head pain, which may be exacerbated by ambient light, particularly bright light, within the user's visual range. individuals may block out all or some portion of ambient light by closing their eyes or wearing a light-blocking mask, and may employ pharmaceutical pain relievers, chilled devices applied, to the forehead or neck, or other such chemical or passive pain relief means. However, not all users obtain sufficient pain relief from such means, and a need for alternative therapeutically beneficial devices remains unfulfilled.

### BRIEF DESCRIPTION OF THE DRAWINGS

FIGS. 1A and 1B diagrammatically depict alternative arrangements of a vibratory structure, according, to an exemplary embodiment of the invention.

FIG. 2 depicts an unobstructed isometric view of the arrangement of components of a pair of vibratory systems as installed within a head wearable apparel item corresponding to the baseball-type cap of FIG. 3, according to an exemplary embodiment of the invention, the structure of the cap being; conveniently bidden from view for clarity.

FIG. 3 is an isometric view of an exemplary baseball-style cap, more particularly depicting an arrangement of discretely concealed components of the invented vibrator structure corresponding to FIG. 2, according to embodiment of the invention,

FIGS. 4-6 are isometric views depicting exemplary head-wearable apparel items, namely a baseball-style cap, a visor, and a stocking cap, including discretely concealed components of the invented vibratory structure, according to alternative embodiments of the invention.

FIGS. 7 and 8 are flow diagrams depicting a method of use of a headwear item having integrated vibratory structure, according to alternative embodiments of the invention.

FIG. 9 is an isometric view depicting an exemplary head-wearable apparel item, namely a mask, including discretely concealed components of the invented vibratory structure, according to embodiment of the invention.

### DETAILED DESCRIPTION OF THE PREFERRED EMBODIMENTS

This description presents numerous aspects of the invention as exemplary embodiments, intended to clearly disclose the features, arrangement of components, function, implementation, benefits, and numerous alternative embodiments contemplated by the inventor. The scope of the invention is not limited, however, solely to the specific structures and operations expressly described, or depicted in the several figures, but additionally includes variations in the particular components, arrangement of components, order of operations, and other features that would be apparent to an ordinarily skilled artisan in view of this application, or that would be recognized as being within the scope of equivalents of the same.

The inventor discovered that applying vibration at one or more locations around the head of an individual with Tourette syndrome during an symptomatic episode, helps to calm the user, correspondingly lessening a degree of disturbance to their outward demeanor. Because the visibly expressed signs of an episode are less noticeable to persons around the individual with Tourette syndrome, as well as to the individual himself, the individual with Tourette syndrome is better able to function in a social setting. The user experiences less disruption to his own activities, is better able to focus, and experiences less stigma that can result from the attendant signs of an otherwise unattenuated episode.

The inventor conceived a structural arrangement and associated method that delivers such beneficial vibratory stimulation in a simple to use, discrete, user-controllable manner. In most embodiments, other than a slight humming sound noticeable only in close proximity to the device, operation of the vibratory structure during use is virtually undetectable to other individuals. Further, the operable components themselves are small, and are so discretely integrated within an otherwise comfortable article of headwear, that the user himself may ordinarily be unaware of them except when actuated and producing vibratory stimulation.

The general concept of the invention involves a device and method suitable for therapeutically and discretely applying vibration at one or more portions of a user's head. Such application can be executed by the user himself, or by a helper such as a clinician, a relative, a care-giver, an instructor, or another third-party. The invented structure is configured to substantially or completely conceal the active components from view within an otherwise-ordinary appearing item of headwear, enabling a user to utilize the device in even public settings without disclosing such use to surrounding casual observers. Even the movements involved in manually activating or deactivating the device could easily be misinterpreted as ordinal garment adjustment actions. Therefore, the user does not sacrifice privacy and confidentiality during, use of the device.

In an embodiment, the invention includes a vibratory structure integrated within the structure of a baseball cap, visor, or other headwear item, in a visually unobtrusively, or even undetectable, manner.

In another embodiment, the invention includes a vibratory structure comprising plural operably-coupled components, arranged and suitable for installing into the structure of an already-manufactured headwear item, in the manner of a retrofit to the headwear item.

In another embodiment, the invention involves a method for integrating and operably coupling components capable of operating as a vibratory structure, into the structure of a headwear item.

In another embodiment, the invention involves a method for therapeutically implementing a headwear item and integrated vibratory structure, to beneficially affect a user experiencing symptoms of one or more physiological conditions, including but not limited to Tourette syndrome or a migraine headache.

In another embodiment, the invention involves a method of configuring a vibratory element and headwear item to enable activation and deactivation of a vibratory function by simply and discretely applying manual pressure at a surface portion of the garment, without removing the garment.

In another embodiment, the invention involves a headwear item and integrated vibratory structure configured to enable simple removal and replacement of a power source (e.g., one or more batteries) suitable to provide operable electrical power to the vibratory structure.

In another embodiment, the invention involves a structure and method enabling a user to consistently and quickly, orientate and operably couple one or more vibratory devices relative to one or more selected portions of the user's head.

As used in this specification and the accompanying claims, the terms ‘therapeutic,’ ‘therapeutically,’ and similar variations are not meant to indicate, suggest, or claim that the disclosed embodiments are capable of curing or causing remission of any disease, injury, or physical or neurological condition. Nor does the applicant claim that the beneficial affects observed in a limited number of users, resulting from one or more of the disclosed embodiments, would be likewise observed in all users, or to the same extent in all users who do experience beneficial results.

Instead, the term ‘therapeutic’ as used in this description and in the claims initially presented or later added or amended, means that use of an embodiment of the invention by a person affected by Tourette syndrome may beneficially affect some users in one or more ways, including but not limited to, (1) delaying onset of a tic, (2) lessening a severity or intensity of a tic, (3) calming the user before, during, or after the onset of a tic, (4) stimulating the development of a beneficial conditioned response, e.g., related to a sense of self-control resulting from actuation of an embodiment of the invented vibratory headwear device related to an onset of a symptom, or (5) distracting a user's attention from an internally perceived stimulus such as a premonitory urge by providing an externally-applied counter-stimulus.

Alternatively, with regard to migraine headaches, ‘therapeutic’ means that a user may find the pain of a migraine more tolerable to some degree, or may be able to relax more readily, due to vibratory stimulation of portions of the user's face or head. User's may experience other physiologically-beneficial results from using embodiments of the invention, and all such results are intended to be within the scope of the term ‘therapeutic’ as used in this description and the accompanying claims.

As an overview, embodiments of the invention generally include a vibratory structure discretely integrated within the structure of a head-wearable apparel, item (‘headwear’). As used herein, the term ‘discretely,’ or ‘discretely concealed,’ generally means that when a user is wearing the headwear item, components of the vibratory structure are not directly visible to persons other than the user, whether or not a fabric or other material at an exterior of the headwear item visibly conforms to a general shape or outline of one or more of the components.

Exemplary vibratory structure typically includes one or more first vibratory elements, an actuation control, either or both of a power source and a retainer for a power source, and one or more electrically conductive lines operably coupling the first vibratory element, the actuation control, and the power source or operable retainer for a power source.

As used in this description and the accompanying, claims, the term ‘operable,’ as in “operably coupled” or “operably configured,” typically means that the described feature, arrangement, or condition is coupled, or configured, etc. in such a way as to enable the vibratory elements to activate when an actuation control (switch) is engaged, closing an electrical circuit of the vibratory structure. Fundamental concepts relating to the function of basic electrical circuits are within the skill of an ordinarily skilled artisan, therefore are not presented in detail in this description.

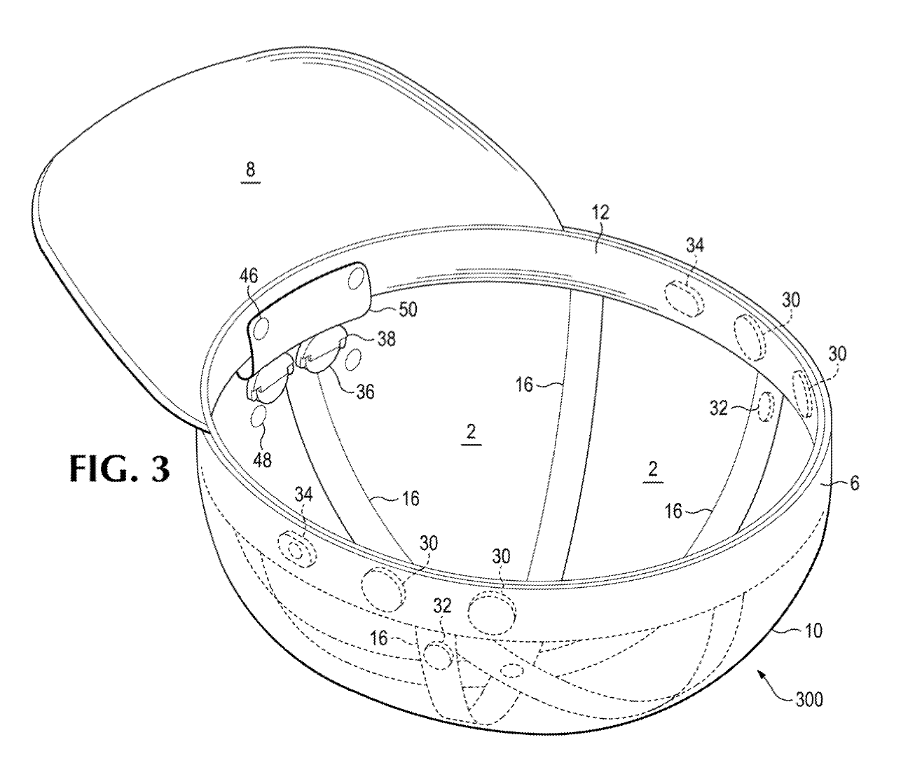

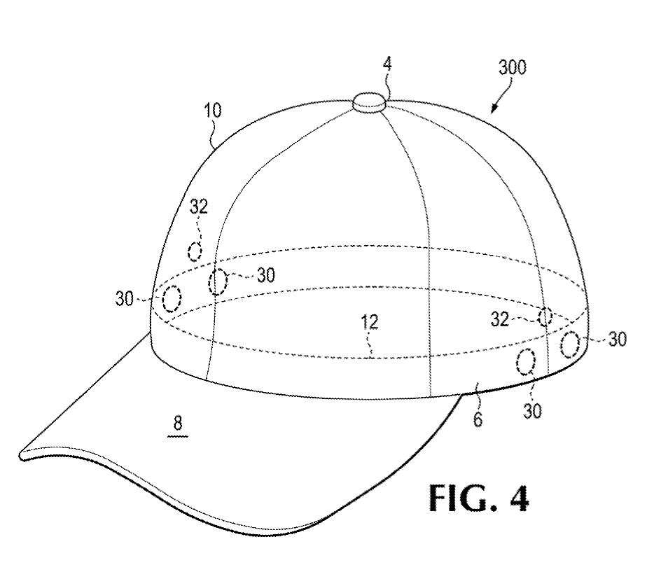

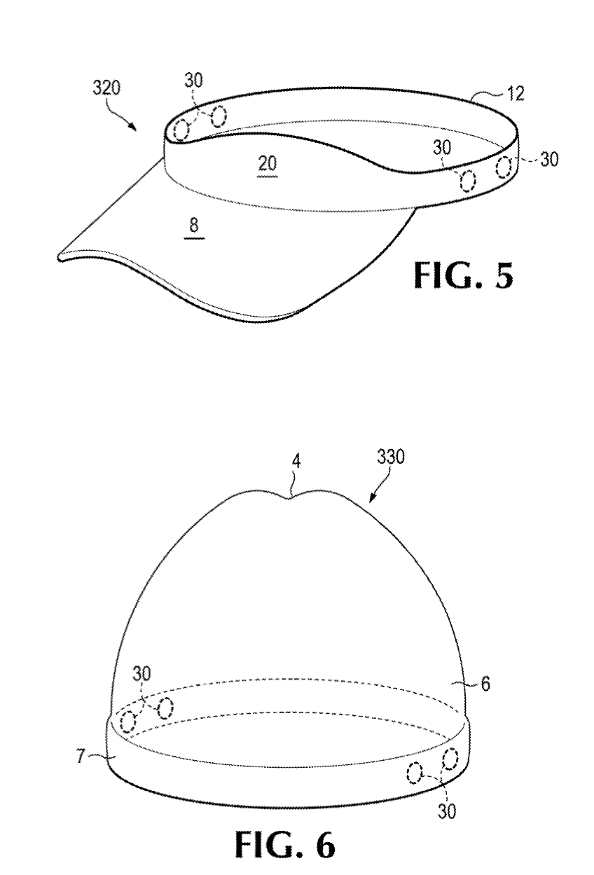

In exemplary non-exclusive embodiments, a vibratory structure is integrated within the structure of a baseball-style cap (or simply “cap” herein; 300 in FIG. 4), or a visor (320 in FIG. 5), or a stocking cap (340 in FIG. 6). Referring to FIGS. 3 and 4, an ordinarily skilled artisan will readily recognize that caps, but not visors, typically include a crown portion 10 (or “crown”) comprising two or more panels 2 joined at seams formed along their adjacent sides. Respective apexes of the panels converge at the top or ‘apex’ 4 of the crown, and the panels' bases generally align in a serial arrangement forming, a circumferential lower ‘rim’ 6 of the crown.

When worn by a user, the crown 10 of a cap encompasses much of the top half of a user's head, and a height from the rim 6 of the crown to its apex 4 defines a lower limit at which the rim will lie with respect to the user's head. Of course, some headwear is configured so that, when worn, a gap exists between the apex of the headwear and the top of a user's head, and the embodiments contemplated herein extend to all forms of headwear, whether close fitting or providing such gap, provided that at least one or more portions of the headwear, e.g., the crown or sweatband, lie in close contact with the user's head during normal wear.

Caps and visors also typically include a bill 8 attached along a rim 6 of and extending outwardly from the crown, as shown. The location of the bill typically defines the front portion of a cap, although baseball caps are frequently worn in a backwards fashion, or ‘reversed,’ with the bill orientated toward the user's rear. For descriptive convenience, and according to the conventional understanding, the portion of the cap at which the bill is attached is considered to be the ‘front’ in this description.

The crown of a visor 320 does not typically extend to or encompass the top of the user's head. Instead, the crown is formed as a band (“headband” herein) that typically encircles the user's head, corresponding to the rim 6 of a cap, and may have a higher (wider) frontal portion 20 that tapers to a lower (narrower) back portion. In other embodiments, the headband is relatively uniform in width throughout its circumference.

For convenience, descriptions of components being disposed relative to a ‘crown’ of a headwear item (e.g., a cap) in the description and in the claims, are intended to likewise encompass components disposed relative to a ‘headband’ of a visor, unless otherwise indicated, or unless an ordinarily skilled artisan would readily recognize that the particular described arrangement inherently excludes a headband of a visor (e.g., a reference to the apex of a crown atop a user's head).

A substantially circumferential “sweatband” 12 is typically coupled at the interior of the crown, most commonly by a line of stitching disposed along a lower edge of the sweatband 12 and the crown 10. The stitching in such embodiments forms a seam, enabling the sweatband to be folded downwardly and away from the interior surface of the crown, and forming a ‘pocket’ between the sweatband and the interior surface of the crown. Alternatively, the bottom edge of the crown may be folded inwardly or outwardly upon itself, in the manner and appearance of an interior or exterior cuff, respectively. In yet another embodiment, a sweatband can be stitched to the crown along both its top and bottom edges, or vertically at intervals around its circumference, or via any combination of such arrangements, or any other that is known in the art.

Although the exemplary embodiments expressly described herein include a sweatband, the embodiments likewise include and encompass caps and devices that do not include a separate sweatband structure coupled to the crown. In such embodiments, the interior surface of the crown adjacent to the rim 6 of the crown, in the same general location that a sweatband would he disposed if present, is nonetheless included within the scope of the term ‘sweatband’ herein.

A portion of the crown, typically opposite the bill, frequently includes a size adjustment feature, or closure, configured to enable a user to adjust a circumferential size of the headband. The size adjustment feature may be configured either as an interruption in continuity of, or as an extension of, the sweatband, or as an additional structure relative to, and in some cases overlying, the sweatband. Many forms of size adjustment features for headwear are well-known in the art, including one or more elongate tabs that overlap one another or overlap or insert into a portion of the crown, a clasp, a buckle, hook-and-loop fastener elements, a snap, a hook, an elastic material or structure, or some other type or arrangement of features enabling adjustment of a circumferential dimension of the crown, and facilitating comfortable yet secure wear by users with different head shapes and diameters. Unless specifically distinguished according to a particular described embodiment, and for descriptive simplicity, references to components being coupled with, integrated within, or otherwise arranged relative to a portion of a sweatband, likewise contemplate that such components can also, according to one or more embodiments, be coupled with, integrated within, or otherwise arranged relative to a size adjustment feature.

Some caps additionally include a liner disposed within the crown, typically formed either of a single expanse of a material (e.g., fabric, leather, hydrophobic membrane, moisture-wicking material, insulating materials, etc.), or of plural panels coupled in a similar manner as the panels of the crown. Such liner typically extends coextensively with, or along some portion of the inner surface of the crown, and can be provided in additional to or alternatively integrated with, the sweatband. Caps can additionally include insulating materials disposed between the crown and such a liner.

Many standard configurations and component pans of caps, visors, and other head-wearable apparel items are well-known, and are not themselves claimed herein as having been conceived by the inventor. Further, numerous variations in the size, shape, and method of wearing typical caps and visors are well-known to an ordinarily skilled artisan, and do not require detailed discussion herein, except to indicate the arrangement of the components within the invented structure, and the operation of the device according to a method of use. Nonetheless, the invented embodiments contemplated and disclosed herein are several, as an ordinarily skilled artisan will recognize.

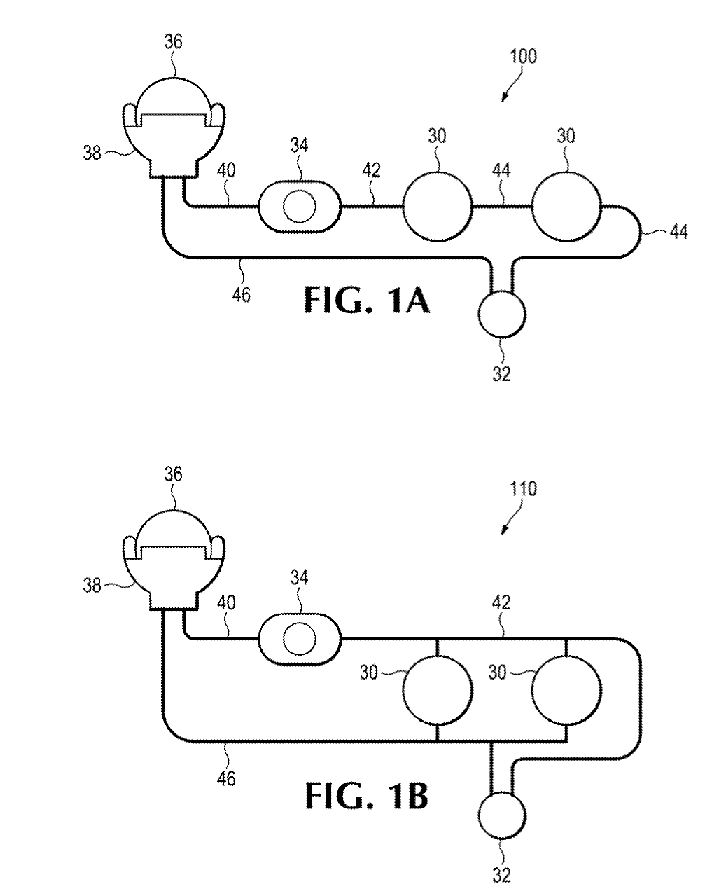

Referring now to the exemplary embodiments depicted in the FIGS. 1A and 1B, a preferred embodiment of the invented vibratory structure comprises one or more vibratory elements 30/32, one or more of either power sources 36 or receptacles 38 for power sources, and one or more actuation devices 34 (“switches” herein), operably coupled via electrically conductive lines 40, 42, 44, 46 to form one or more electrical circuits. The number of vibratory elements can vary nearly without limitation across the contemplated vibratory structure embodiments, but will normally include at least one The number, size, type, and power output or other electrical characteristics of the power source(s) can likewise vary across the contemplated embodiments, particularly to ensure adequate power is available to operate a particular number or type of selected vibratory elements included in a vibratory structure.

Contemplated vibratory structure embodiments normally will include at least one power source, the embodiments also contemplate that a vibratory structure may include only a receptacle for a power source, such as an operable battery retainer or a connector e.g., receptacle) for receiving connection of a power supply line, enabling, a power supply (e.g., a battery, a power supply line, etc.) to be operably coupled with the vibratory structure at any time prior to actuation of the vibratory structure.

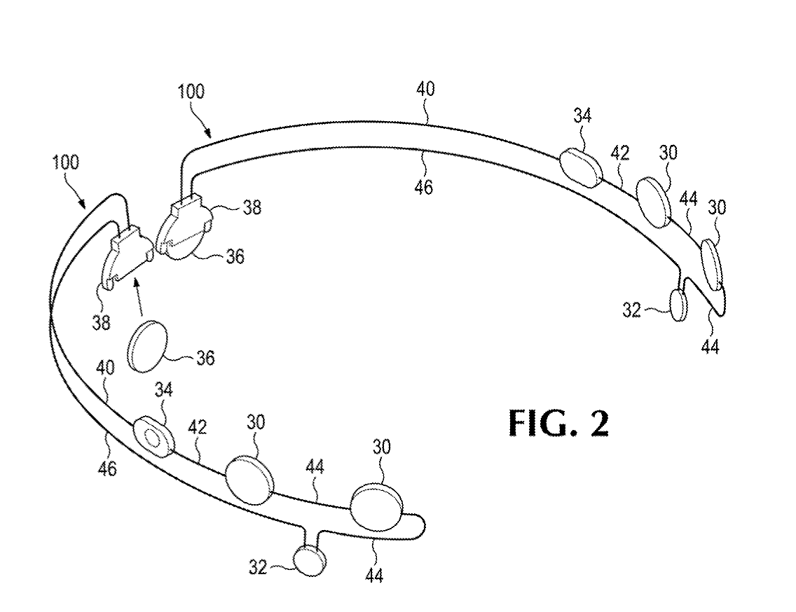

As shown in FIGS. 2 and 3, a cap can include two separate, correspondingly-configured vibratory structures, one disposed at each ‘side’ of the cap. The separate vibratory structures can be arranged and integrally installed within the structure of the cap during assembly of the cap, or can be installed at some time after assembly of the cap is complete, in the manner of a retrofit. Alternatively, rather than two separately operable vibratory structures, vibratory elements on both sides of a headwear item can be connected within a single operable vibratory structure, e.g., operated by a single switch and deriving power from a common power source or set of power sources.

In a preferred embodiment, one or more vibratory elements 30 are disposed along the circumference of the sweatband 12, typically sandwiched between the sweatband and the interior surface of the crown. As in the exemplary embodiments shown in FIGS. 3-6, vibratory stimulation is beneficially applied at lateral portions of the user's head, and the one or more vibratory elements 30 are disposed at intervals along the sweatband 12 between the front and back of a cap or other headwear item. The spacing between the vibratory elements can be at either regular or irregular intervals, and such intervals can be either fixed or variable. Such spacing can be customized by positioning and spacing the vibratory elements in a cap according to an arrangement that the particular user finds beneficial, or by placing vibratory elements at locations and a spacing that are either known or expected to be beneficial to one or more other users.

As shown according to the exemplary embodiments of FIGS. 3-6, a pair of vibratory elements 30 are disposed between a sweatband 12 and rim 6 of a crown 10, positioned to lie slightly fore and aft of the user's ear when the cap or other headwear item is worn with the bill or other front portion of the headwear item orientated forwardly. A third vibratory element 32 is disposed at a portion of the crown that is higher relative to the rim 6 (e.g., closer to the apex 4) than either of the other two vibratory elements 30, and positioned to align approximately along a midline extending vertically through the user's ear. Together with vibratory elements of a vibratory structure correspondingly disposed at the opposing side of the hat 10, the exemplary embodiment provides a six-point massage to the user's head when actuated.

Alternative embodiments can likewise include fewer or more vibratory elements, or can alter the separation or relative positioning of the vibratory elements from those shown in FIGS. 3 and 4, without departing from the scope and spirit of the invention. Likewise, plural vibratory structures can be alternatively disposed in a headwear item, to enable the user to selectively actuate vibratory stimulation to any one or more of a front, back, top, or bottom portion of a selected headwear item, or to any particular one or more vibratory elements disposed at any selected portion of the headwear item.

While the exact location of the one or more vibratory elements can vary between embodiments, positional stability of the vibratory elements within the cap during use is preferred, and therefore is enabled in embodiments. Vibratory elements can be affixed to the crown 10, or to the sweatband 12, or sandwiched between the crown and sweatband, in a manner that prevents relative motion between the vibratory elements 30 and portions of the cap. For example, a vibratory element can be sewn into a closely-conforming pocket between the sweatband and crown, preventing dislocation of the vibratory element. Alternatively, a vibratory element can be affixed to a portion of the headwear item by a fastener (e.g., a pin, a rivet, a post-and-clamp arrangement, etc.), by an adhesive, by stitching, by securing the vibratory element beneath a swatch of a backing material affixed to the crown or sweatband, or by some other means of attachment suitable to prevent a component from positionally displacing relative to a portion of the headwear, during handling, operation, or when donning or doffing the headwear.

Additionally, or alternatively, as shown in FIG. 3, a vibratory element 32 can be disposed between the crown 10 and a strip of material 16 overlying a cross-seam, being concealed from direct view from both of the interior and exterior of the cap. As shown, the vibratory element 32 is disposed at a higher portion of the crown 10 (relative to the users' head) than is either of vibratory elements 30, to provide stimulation to portions of a user's head other than those directly overlaid by the sweatband 12.

In a typical embodiment, each vibratory element comprises a relatively compact, electrically-powered component. In a preferred embodiment, the vibratory element has a generally flattened, coin-like shape, particularly suitable for being held in vibratory contact with a user's head by a sweatband of an otherwise comfortably-fitted cap, without causing the user discomfort due to localized pressure. Such motors are available from numerous manufacturers, particularly companies such as Zhejiang Yuesui Electron Stock Co., Ltd. of Zhejiang, China (“Yuesui”), Constar Micromotor Co., LTD of Guangdong, China (“Constar”), and others. As mentioned, a user wearing, a preferred embodiment of the invention generally will not notice the presence of the vibratory elements when not actuated, due to their generally small size and flattened configuration.

Suitable exemplary vibratory elements 30 are referred to as ‘eccentric rotating mass’ motors (or for simplicity in this description, rotary vibrating motors), for example, in which an eccentric (accordingly, imbalanced) internal rotor spins within a housing, producing a vibratory frequency corresponding to a speed of rotation of the rotor. The rotor may spin on a rotating shaft, or may alternatively be shaftless, as both types are known and used in various electronic devices. Alternatively or additionally, a suitable vibratory element 30 can comprise a ‘linear vibratory motor’ (also known as a ‘linear resonant actuator vibration motor’). For example, a linear coin vibrating motor has an internal moving mass that moves in a linear axis (e.g., Y-axis, Z-axis, etc.) within a housing, with such movement being actuated and sustained by application of an electrical current, and by response of a spring, for example, positioned between the moving mass and an internal portion of the housing. Exemplary linear motors include the so-called PRECISION HAPTIC(™) Y-axis (e.g., model number C10-100) and Z-axis linear resonant actuators available from Precision Microdrives of London, England.

One type of vibratory element 30 that provides suitable performance, and can be disposed discretely on, within, or behind a sweatband 12 of a cap in exemplary, non-exclusive embodiments, is known as a ‘coin’ or ‘pancake’ ‘vibrating motor,’ (collectively, for descriptive simplicity, ‘coin vibrating motor’), due to their flattened and generally rounded shape. Coin vibrating motors typically have a diameter (or width) that is greater than their thickness, in the manner of a coin. For example, one common size of coin vibrating motor is referred to as a ‘1434’ motor. As denoted by its numerical identifier, a 1434 motor has a diameter of approximately fourteen millimeters (14 mm), and a thickness of approximately three and four-tenths millimeters (3.4 mm). Alternatively, other exemplary vibratory elements designated by their sizes can also be used in embodiments, such as ‘1234’ motors (12 mm diameter×3.4 mm thick), ‘1030’ motors, ‘1034’ motors, ‘1227’ motors, and others, as would be recognized by an ordinarily skilled artisan. In general, any vibratory motor that can be discretely concealed within an item of headwear, and can operate from a power source that is likewise discreetly concealable within an item of headwear, is considered suitable and is within the scope of the contemplated embodiments.

Coin vibrating motors and other suitable vibratory elements also generally include electrically conductive lines (e.g., leads, wires, etc.) suitable for operably connecting the motor within an electrical circuit. Alternatively, a vibratory element may include electrically conductive terminals of any of a wide variety of configurations (e.g., pins, ports, clamps, spring contacts, etc.), to which a user can operably couple electrically conductive lines. Generally speaking, nearly any configuration of electrically coupling a vibratory element with a power supply in a manner that can be discretely disposed within or coupled with a headwear item, can be used according to alternative embodiments, and all such configurations are intended to be included within the scope of the contemplated embodiments.

Another vibratory motor suitable in an embodiment for concealment behind a strip of backing material 16 along a cross-seam in the manner of vibratory clement 32 of FIG. 3, is a ‘1020’ coin vibrating motor (the “1020 motor” hereinafter, also available from Constar). The 1020 motor has a diameter of approximately ten millimeters (10 mm) and a thickness of approximately two millimeters (2.0 mm). Such dimensions also make the 1020 motor suitable for discrete placement within, behind, or adjacent to a sweatband of a baseball cap in an exemplary embodiment. Of course, such dimensions are exemplary only, and do not limit the scope of alternative vibratory elements or dimensions that would be suitable in other embodiments.

For example, the Constar 1020 motor (part number 1020RFN31-12d) is described as a high speed, brushless DC motor with an internal eccentric rotor, a starting voltage of 2.3 volts (2.3V), an operating voltage of three volts (3V), and an operational speed in the range of 10,000-13,500 revolutions per minute (RPM), Constar and other manufacturers likewise provide a large number of other suitably sized (e.g., ‘coin-type,’ or ‘pancake’) vibratory motors, used in products such as tablet computers, mobile phones, and other such compactly-sized devices, which can be beneficially utilized in the contemplated embodiments.

Exemplary vibratory elements generally provide a beneficial vibratory ‘speed,’ or frequency falling within the range a approximately one thousand to fifteen thousand oscillations per minute (1000-15,000 OPM). Preferably, vibratory elements will provide a vibratory speed within the range of five thousand to fifteen thousand (5000-15,000) OPM, to provide a ‘smooth’-feeling stimulation, or a higher frequency humming sound that may be soothing to a user. In a still further preferred embodiment, vibratory elements provide a vibratory speed within the range of ten thousand to fifteen thousand (10,000-15,000) OPM, providing a yet smoother-feeling stimulation and higher frequency humming sound. In a still further preferred embodiment, the vibratory elements provide a vibratory speed found within the range of ten thousand to thirteen thousand five hundred (10,000-13,500) OPM, providing a vibratory sensation and audible humming that is comfortable and beneficial to a wide number of users, without being too fast or emitting too high-pitched of a humming noise for some. For descriptive simplicity, a single revolution of an eccentric rotor in a rotary vibratory motor, and a single bi-directional cycle in a linear vibrator, are each considered to equate to a single ‘oscillation’ as that term is used in this description and the accompanying claims.

The invented embodiments also include one or more power sources 30 operably coupled with the one or more vibratory elements 30, 32 via one or more electrically conductive pathways, or “lines” (e.g., wires, printed circuit traces on a substrate, flexible cables, etc.) 40, 42, 44, 46. The exemplary electrically conductive lines shown in FIGS. 1A-1B and FIG. 2 are not exclusive, but provide a clear understanding of an operable electrical circuit according to an embodiment of a vibratory structure. As will be understood from FIGS. 1A and 1B, the vibratory elements 30, 32 of the exemplary vibratory structure 100, 110 can be arranged either in serial or in parallel in an operable electrical circuit. For example, in the serially coupled embodiment of FIG. 1A, line 40 couples a battery 36 and battery retainer 38 with a switch 34; line 42 couples the switch with a first vibratory element 30; lines 44 couple one or more additional vibratory elements (e.g., 32) sequentially with the first vibratory element; and line 46 completes the circuit by coupling a last of the sequentially coupled vibratory elements 32 with the battery 36 and battery retainer 38. In an embodiment having only one vibratory element, line 44 would be omitted, as would be recognized by an ordinarily skilled artisan.

Alternatively, as shown in FIG. 1B, an electrically conductive ‘supply’ line 42 extends directly from the power source 36, 38 to each of two or more vibratory elements 30, 32, and an electrically conductive ‘return’ line 46 extends from the two or more vibratory elements 30, 32 back to the power source 36, 38, with the actuation control 34 being disposed within either the supply line 42 as shown, or in the return line 46. Further alternative arrangements include, but are not limited to either: (a) individual supply lines extending from the power source to each of the two or more of plural vibratory elements, or (b) individual return lines extending from each of the two or more plural vibratory elements to the power source. Whether coupled together serially or in parallel within an electrically conductive circuit, each vibratory element in a vibratory structure is operably coupled with a power supply, and can be actuated by an actuation control of the vibratory structure 110.

As shown in FIG. 3, a power source 30 can be conveniently disposed inside the crown 10 at or near the front portion of a headwear item 300. Of course, the power source can alternatively be disposed in another portion of the headwear according to alternative embodiments, with the one or more electrically conductive lines being suitably routed, to one or more of the other components of the vibratory structure from any such selected alternative location. An ordinarily skilled artisan will recognize that the pair of vibratory structures 100 shown according to the embodiment in FIG. 2 could be placed m a headwear item with the batteries orientated toward the front, or alternatively, with the batteries orientated toward the back of the headwear item, and in either case, the vibratory structures 30, 32 will be easily disposed along lateral portions of the user's head.

For convenience and portability, a typical embodiment utilizes one or more batteries 36, which individually or collectively provide a suitable electrical signal. In any particular embodiment, a “suitable electrical signal” is one having characteristics (e.g., voltage, amperage etc.) sufficient to operate the selected one or more vibratory elements. In view of this detailed description, an ordinarily skilled artisan will be able to select a power source providing such suitable electrical signal characteristics for the one or more vibratory elements selected for use in a vibratory structure.

A typical embodiment utilizes one or more cylindrical and relatively flattened ‘coin cell’ or ‘button cell’ batteries 36 (collectively “button cell” for convenience herein). For example, 2032-type, three volt (3V), lithium electrode button cell batteries, which are widely used in consumer products such as computers, calculators, and other small electrically-operated devices, are used in a preferred but non-exclusive embodiment. A 2032-type coin cell battery has a diameter of approximately twenty millimeters (20 mm), and a height of approximately three and two-tenths millimeters (3.2 mm), making such batteries particularly suitable for being discretely concealed between a sweatband and crown of a headwear item. Such dimensions help conceal the battery from view of others, while also being relative unobtrusive to the wearer of the headwear item.

A power source is typically operably coupled within the electrical circuit of a vibratory structure via one or more electrically conductive lines (e.g., wire, cable, ribbon, etc.). The lines may be coupled directly with a battery by soldering an exposed metal wire to an anode or cathode of the battery; however, in a preferred embodiment, the battery is retained within a battery holder, or “retainer.”

Typically, a battery retainer includes a receptacle formed of a generally non-conductive material (e.g., plastic), and further includes electrically conductive structures (or “contacts”) positioned and configured to provide and maintain electrical continuity with the anode and cathode of a battery properly installed within the battery retainer. The contacts of the battery retainer are each, in turn, electrically coupled with one or more electrical lines of an operable electrical circuit. Because the structure of the retainer includes such contacts, and provides an operable electrical connection between a battery and electrically conductive lines of an electrical circuit, the retainer is referred to in this description and in the accompanying claims as being an “operable retainer.”

Further, a battery retainer is typically configured to receive and retain a battery securely, yet removably. Numerous alternative battery retainer configurations are available for 2032 coin cell batteries, as well as for other types and configurations of batteries. For example, some battery retainers are configured to receive a coin cell battery inserted edgewise, as shown in FIG. 2, with the battery being retained by compressive forces exerted by the contacts, or by elastic structures formed into or extending from a receptacle of the battery retainer, or by a combination of both. One such exemplary embodiment is identified as a Vertical Lead Coin Cell Battery Holder, model number CH74-2032, available from Comfortable Electronic of New Taipei, Taiwan.

Alternatively, numerous forms of coin cell battery retainers receive relatively parallel planar insertion of a coin cell, and the battery is retained in position by one or more elastic or spring-loaded retention structures. One such exemplary but non-exclusive example is disclosed in U.S. Pat. No. 4,487,820.

Of course, the embodiments can likewise include alternatively configured power sources, such as well-known AAA or 123 canister-style batteries, and correspondingly configured operable retainers. Headwear configured to enable concealment of such batteries include helmets, cowboy hats, highly-insulated caps, or other hats having high crowns or otherwise providing sufficient space between the user's head and the crown to contain and conceal from view such batteries and retainers.

As shown reflected back in FIG. 3, a patch-like shield 50 is provided in an embodiment, behind which one or more batteries or battery retainers, or other components of the vibratory structure, can be concealed. However, during use, the shield will generally lie in a relatively flattened manner along or against an inner surface of the headwear, providing a material layer between the batteries and a user's head. The shield 50 can be simply an expanse of a textile, formed of either or both of natural and synthetic fibers, or could alternatively comprise an expanse of a polymer foam material, or leather, or a mesh screen, or any other material or composition suitable to provide a cushioning or barrier layer between a user's head and one or more components of the vibratory structure.

The shield 50 typically includes one or more attachment means, for attaching it to either a portion of the headwear item, or a component of the vibratory structure, or both. For example, the exemplary shield in FIG. 3 includes four small ‘coins’ 46 of a hook-and-loop fastener material arranged in correspondence with four reciprocal coins 48 disposed at an inner, frontal portion of the cap's crown 10, enabling a user to detachably affix the shield to the inner surface of the crown in position to cover the batteries 36 and retainers 38. Alternative detachable attachment means can include one or more of a pin, an adhesive, a clasp, a magnet, a hook, a zipper, a button, a snap, a lace, or any other such fastener or attachment as would be apparent to an ordinarily skilled artisan, and in view of this description. An arrangement or feature for coupling a shield 50 with a headwear item can likewise be configured to form either a flap (as shown in FIG. 3) or a pocket for concealing one or more components of the vibratory structure 100. Alternatively, one or more edges of the shield 50 can be permanently coupled with a headwear item 300, by stitching one or more edges of the shield directly to either of the crown 10 or the sweatband 12, or to a portion of the bill 8, for example.

A switch 34 is coupled within the operable electrical circuit in a typical embodiment, providing a means to alternatively enable or disable flow of an electrical current through the electrical circuit, and correspondingly to cause the vibratory elements to activate or deactivate, respectively. In a preferred embodiment, the switch device is manually operable by a user, providing easy control over an operational status of the vibratory elements. Although FIGS. 2 and 3 depict an actuation button of the switch 34 facing outwardly away from a user's head, an actuation button can face inwardly toward the user's head in an alternative embodiment.

Numerous suitable types of switches are contemplated according to alternative embodiments. In a preferred embodiment, the switch is compact in size (e.g., a micro-switch), and is configured for push on, push of operation. One such exemplary switch part no DC3coint available from Evan Designs of Broomfield, Colo. has dimensions of approximately 8 mm×12 mm×8 mm tall, is electrically rated at 1 Amp, 24 volts, and is available already coupled with a battery retainer.

An embodiment of the invented vibratory structure 100, 110 further comprises an operable system of components that can be arranged and suitably configured so that it can be inserted as a unit into a selected head-wearable apparel item. For example, a selected head-wearable apparel item may be a baseball-style cap, and the vibratory structure can be configured substantially as shown in FIG. 2. An entire pre-assembled vibratory structure so configured can then be installed into a cap by disposing the vibratory elements and interconnecting electrically conductive lines between the sweatband and the crown, or at a portion of the crown.

When integrated into a head-wearable apparel item as shown in FIGS. 3-6, the invented head-wearable structure facilitates the therapeutic application of vibration to the head of a human subject affected by Tourette syndrome. Such application typically involves disposing the headwear item upon the head of a human subject known to exhibit signs of Tourette syndrome, and actuating a vibratory element of the vibratory structure either in response to a then-present condition, or preparatory to the anticipated or imminent condition.

In particular, a condition the presence of which may indicate responsively applying therapeutic vibration delivered via the invented headwear can include any one of, or any combination of, the following: (1) the subject detecting a premonitory urge; (2) the subject exhibiting behavior consistent with a vocal tic, a physical tic, or both of a vocal tic and a physical tic; (3) introducing the subject to a stimulus objectively likely to induce one or more of a premonitory urge, a vocal tic and a physical tic; (4) the subject entering into an environment objectively likely to induce one or more of a premonitory urge, a vocal tic and a physical tic; and (5) the subject entering an environment in which the subject desires to mitigate an outwardly detectable expression of either or both of a vocal tic and a physical tic.

Alternatively, an anticipated or imminent condition, preparatory to which therapeutic vibration may be delivered to a subject via, the invented headwear, can include any one of, or any combination of, the following: (1) introducing the subject to a stimulus objectively likely to induce one or more of a premonitory urge, a vocal tic and a physical tic; (2) the subject entering into an environment objectively likely to induce one or more of a premonitory urge, a vocal tic and a physical tic; and (3) the subject entering an environment in which the subject desires to mitigate an outwardly detectable expression of either or both of a vocal tic and a physical tic.

For the purposes of this description and the accompanying claims, a stimulus, environment, or other condition is considered ‘objectively likely’ to induce one or more of a premonitory urge, a vocal tic and a physical tic, if such stimulus, environment, or condition is known to have previously induced such responses either in the particular individual with Tourette syndrome considering use of the invented embodiments, or is known to have previously induced such responses in other individuals having Tourette syndrome.

The particular stimulus, environment, or condition need not be identical to a previously shown response-inducing stimulus, environment, or condition. For example, an individual with Tourette syndrome may have previously reacted to loud music by exhibiting tics, and so loud music can be considered a possible response stimulating condition, without regard to the particular type of music, or the environment within which the subject is exposed to the loud music, or other particulars. Of course, repeated episodes of premonitory urges and tics in response to a particular condition or environment will provide a user with additional information, and perhaps increased confidence, regarding the types of conditions and stimuli that will induce a response, enabling more precision and predictability regarding when to apply therapeutic application of vibration via the invented apparatus, system and method embodiments described herein.

In the past, some individuals with Tourette syndrome have been ejected from buses, theaters, and other locations due to their physical or vocal tics interfering with the enjoyment or productivity of others, or simply due to a high level of misunderstanding regarding Tourette syndrome among the general public. For example, Tourette tics are sometimes misinterpreted as signs of a mental illness, or as the individual intentionally trying to create a disturbance or call attention to themselves, or trying to be intentionally offensive to others, particularly in the case of vocal tics. Suppressing, mitigating, avoiding, or otherwise rendering less detectable the tics and other outward expressions caused by Tourette syndrome enables individuals with Tourette syndrome to better ‘fit in’ and function more comfortably and safely within various public and other social settings.

For these reasons, as well as others, an individual with Tourette syndrome may desire to mitigate an outwardly detectable expression of either or both of a vocal tic and a physical tic in public settings where the types of tics experienced by the individual could cause a disruption, or interfere with the enjoyment of either the subject or others, or cause embarrassment or hardship to the individual, or may even subject the individual to legal consequences or inconveniences. Examples of such environments include, but are not limited to, aboard public transportation vehicles, in a classroom or library, during a concert/play/movie, at a business meeting, in church or at a hospital, and many others too numerous to list. Likewise, individuals with Tourette syndrome may wish to suppress the expression of tics in private settings and activities, such as when driving, or in a home when a baby is sleeping, or when having guests over for dinner, or others too numerous to list.

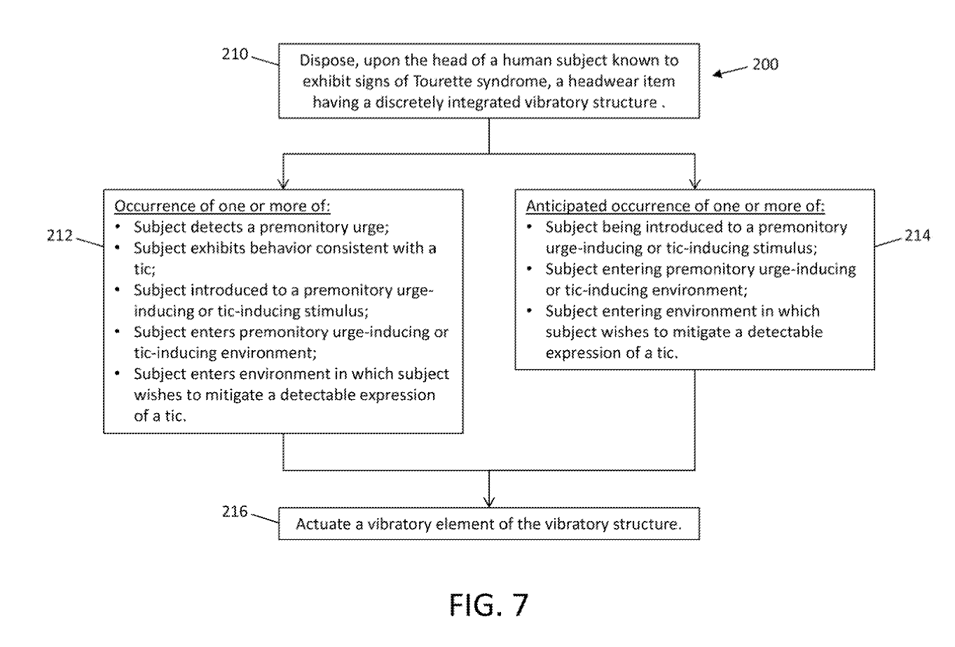

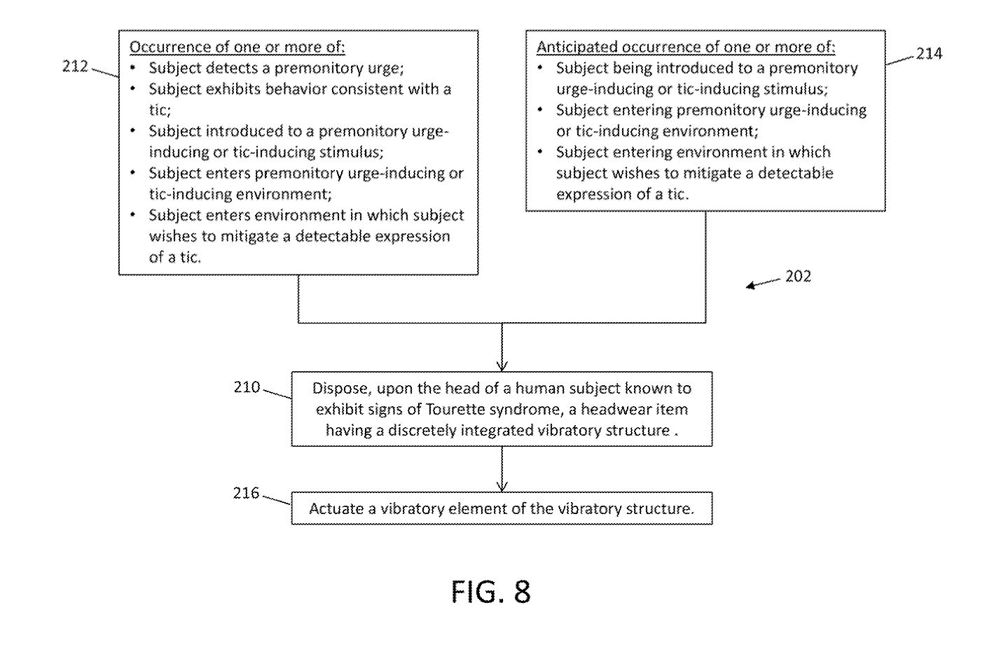

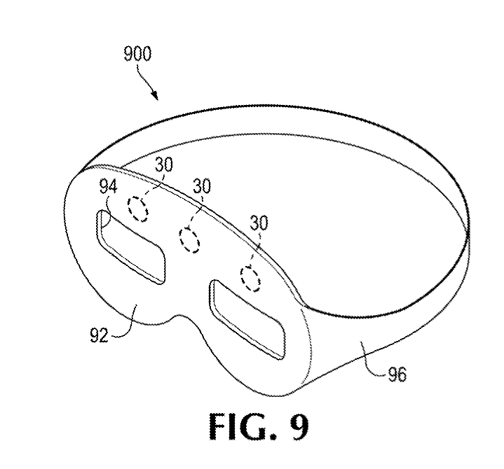

An ordinarily skilled artisan will understand, as shown by the method embodiment 202 in FIG. 8 relative to the method embodiment 200 in FIG. 7, the particular order of operations in the disclosed method embodiments can be altered without departing from the spirit and scope of the invention. Additionally, although not shown, an order of performing operations 210 and 216 can be reversed in the embodiment of FIG. 8, for example, such that a vibratory element of the vibratory structure is actuated prior to disposing a headwear item upon the head of the human subject.

The above described structural and methodological embodiments of the invention do not, however, absolutely define the limits of the contemplated embodiments of the invention. For example, other types of suitable actuation controls contemplated for use in alternative embodiments, can include so-called rocker switches, slide switches, toggle switches, dial switches, or others as would be recognized by an ordinarily skilled artisan. In at least one contemplated embodiment, the actuation control is configured as or is operably coupled with, a rheostatic control, enabling a user to adjust an oscillatory/vibratory speed of one or more vibratory elements. Alternatively, an actuation control can include plural predetermined settings, enabling a user to select from among plural vibratory speeds corresponding, respectively to the plural settings.

In headwear having a crown comprising multiple layers (e.g., an inner liner and an outer layer, an insulating material disposed as a mid-layer, etc.), one or more of the described components of a vibratory structure can be disposed within any one of more of the layers, or between any two of the layers, or can be otherwise coupled with any one or more of the multiple layers.

In stocking caps or other types of hats typically worn with an outwardly-turned cuff 7 at the base of the crown 10, as shown in FIG. 6, one or more of the components of a vibratory structure, or an entire vibratory structure, can be discretely disposed between the outwardly-turned cuff 7 and the rim 6. Accordingly, such component(s) or vibratory structure can be coupled with the rim of the crown so that folding the cuff 7 upwardly discretely covers them. Alternatively, the component(s) or vibratory structure can be coupled with the cuff portion, so that folding the cuff upwardly discretely conceals them and disposes them in position relative to the user's head.

In an embodiment, either the entire vibratory structure or some portion therefore, can be arranged and affixed to a flexible, semi-rigid, or rigid expanse of a backing matter, prior to coupling the vibratory structure with or within an item of headwear. The expanse of backing material can be provided with one or more attachment means (e.g., hook-and-loop fastener elements, etc.) enabling, the integrated vibratory structure and backing material to be disposed within a headwear item as a unit, and enabling unitary removal or repositioning of the vibratory structure.

Alternatively, any one of or combination of the components of a vibratory structure, in particular a switch, a battery, and a vibratory element, can each be individually or collectively provided with one or more attachment means, enabling a user to reposition, rearrange, or reattach any one or more of such components relative to a headwear item, whether to enhance comfort or concealment, or to enhance or attenuate a level or location of vibration applied to the user's head during use.

In at least one embodiment, a coupling between one or more of the components within a vibratory structure, such as between a vibratory element and an electrically conductive line, can be disconnected and reconnected easily by the user. Such configuration and capability can enable easy replacement of individual components for repairs or upgrades, or to enable insertion of one or more additional vibratory elements, power sources, switches, or electrically conductive lines into the vibratory structure. Therefore, a user can reconfigure, expand, alter, rearrange, extend, shorten, or otherwise alter an arrangement and configuration of components in a vibratory structure, whether to fit the user's particular preferences or therapeutic needs, or to enable a single vibratory structure to be interchangeably used in multiple items of headwear.

Accordingly, interconnections between components, or between components and electrically conductive lines, can include one or more of any suitable detachable and re-attachable or interchangeable configuration, including but not limited to clamping connectors, spring-tensioned connectors, screw-tightened connectors, pin-and-receptacle type connectors, blade-and-receptacle connectors, or any others known in the art.

In at least one contemplated embodiment, the headwear is configured as a mask 900, as shown according to the exemplary but non-exclusive embodiment depicted in FIG. 9. A beneficial use for a mask having one or more vibratory structures includes therapeutic application to an individual experiencing, a migraine headache.

As depicted, a mask 900 includes a frontal portion 92 configured to lie adjacent a portion of the user's face. The depicted frontal portion 92 includes plural openings 94 configured to align with the user's eyes when worn, In an alternative embodiment, the frontal portion does not include eye openings, and blocks the user's eyes from exposure to most or all ambient light during use. This latter embodiment is useful because for many individuals, exposure to light, particular bright light, aggravates migraine pain, and a light-blocking mask beneficially addresses such sensitivity.

A vibratory structure coupled with the mask 900 includes one or more vibratory elements 30 arranged along a top portion or ‘brow’ of the mask. The vibratory elements 30 may be of any of the types described above relative to the cap and visor embodiments, for example oscillatory or linear coin vibratory motors, that can be suitably disposed discreetly within or otherwise coupled with the mask. When a user dons the exemplary mask 900 depicted in FIG. 9, in a manner that would be readily understood by an ordinarily skilled artisan, a vibratory element is disposed above each eye, adjacent either the user's brow or a lower portion of the user's forehead, and another vibratory element is disposed above the bridge of the nose approximately centrally between the user's eyes.

The vibratory elements 30 can be alternatively or additionally disposed at other portions of the mask 900, and configured to lie adjacent a portion of the user's face, such as at one or more positions around the user's eye, or lying adjacent to a user's cheekbones or temples (temporal areas). For example, one or more vibratory elements can be provided near the lower edge of the frontal portion 92 of the mask, and configured to lie adjacent the bone(s) underlying, an upper portion of the user's cheek or a lower portion of the user's eye socket.

Further still, other embodiments can include one or more vibratory elements 30 disposed in a side portion 96 of the mask 900, and configured to lie adjacent a side of the user's head when the mask is worn during, use.

The remainder of the components of the vibratory structure (e.g., a switch and. a battery/retainer), and the arrangement and configuration of such components in a vibratory structure for use within a mask 900, are contemplated as being similar or identical to those in one or more of the already described cap or visor embodiments. In particular, a switch and a battery/retainer will generally be operably coupled, via electrically conductive lines for example, with the one or more vibratory elements 30. However, the orientation of the vibratory structure within the mask 900 will typically, although not exclusively, be reversed relative to a typical cap embodiment, with the vibratory elements 30 disposed in the frontal portion of the mask., as shown in FIG. 9, and either or both of a switch and a battery/retainer disposed at a side portion 96 or a rear portion of the mask.

The vibratory structure can be discreetly integrated within the structure of a mask 900 forming a single unitary, vibratory structure and headwear item. Alternatively, the vibratory structure can be assembled and configured for installing discreetly into an already-manufactured mask, in the manner of a retrofit to the mask. The electrically conductive lines coupling any component of the vibratory structure with any other component of the vibratory structure in a mask 900 can be the same (e.g., materials, construction, arrangement, etc.) as any one or more of the electrically conductive lines described, above with regard to an exemplary vibratory structure embodiment for use in a cap, visor, or other item of headwear.

Upon experiencing pain or other sensations consistent with either the onset or the presence of a migraine headache, a user will don the mask in a manner that should be apparent to an ordinarily skilled artisan based on FIG. 9 and this description, and secure the mask in position. The user will then activate (turn on) the vibratory elements via the actuation switch. As with all of the described and contemplated embodiments, operation of the vibratory elements presumes that an operable power supply is provided as described, typically a battery having a sufficient charge to cause the vibratory elements to produce oscillatory vibrations. The user can then deactivate the vibratory elements via the actuation switch at a time of the user's choosing.

Although the description above expressly discloses numerous exemplary embodiments, an ordinarily skilled artisan will readily recognize that the present invention is not limited to the particular methods or details of construction, fabrication, material, size, shape, method of use or operation, or application of the exemplary embodiments expressly described and illustrated herein. Indeed, any suitable variation of fabrication, use, or application that is inherently or impliedly disclosed by the description, drawings, and claims, as would be recognized by an ordinarily skilled artisan, is intended to fall within the spirit and scope of at least one embodiment the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A head-wearable apparel item with integrated vibratory structure, comprising:
an item of headwear; and
a vibratory structure disposed within the headwear item, the vibratory structure including:
a first vibratory element;
an actuation control;
either or both of a power source and an operable retainer for a power source; and
one or more electrically conductive lines operably coupling the first vibratory element, the actuation control, and either or both of the power source and the operable retainer for a power source.

2. The head-wearable apparel item and vibratory structure of claim 1, wherein the power source is a button cell battery.

3. The head-wearable apparel item and vibratory structure of claim 1, wherein the first vibratory element is a coin cell vibratory motor.

4. The head-wearable apparel, item and vibratory structure of claim 1, wherein the item of headwear is one of as baseball-style cap, or a visor, or a mask.

5. The head-wearable apparel item and vibratory structure of claim 1, wherein the retainer for the power source is configured as a receptacle suitable to receive insertion of a. battery.

6. The head-wearable apparel item and vibratory structure of claim 1, wherein either or both of the first vibratory element and the actuation control is concealed either between a sweatband and a crown of, or within, a sweatband of, the headwear item.

7. The head-wearable apparel item and vibratory structure of claim 1, further comprising:
a second vibratory motor operably coupled via the one or more electrically conductive lines with each of the actuation control and either or both of the power source and the operable retainer for a power source.

8. The head-wearable apparel item and vibratory structure of claim 7, wherein the second vibratory element is concealed either between a sweatband and a crown of, or within a sweatband of the headwear item.

9. The head-wearable apparel item and vibratory structure of claim 7, wherein the second vibratory motor is disposed at a higher portion of a crown of the headwear item than is the first vibratory motor.

10. The head-wearable apparel item and vibratory structure of claim 1, wherein the actuation control is configured for push on, push off operation.

11. A method for therapeutically applying vibration to the head of a human subject affected by Tourette syndrome, comprising:
disposing a headwear item upon the head of a human subject known to exhibit signs of Tourette syndrome, wherein:
the headwear item includes a vibrator structure discretely integrated within the headwear item, and
a vibratory element of the vibratory structure is disposed adjacently and in vibratory contact with a portion of the user's head; and
actuating the vibratory element either in response to one or more of:
the subject detecting a premonitory urge,
the subject exhibiting behavior consistent with a vocal tic, a physical tic, or both of a vocal tic, and a physical tic,
introducing the subject to a stimulus objectively likely to induce one or more of a premonitory urge, a vocal tic and a physical tic,
the subject entering into an environment: objectively likely to induce one or more of a premonitory urge, a vocal tic and a physical tic,
the subject entering an environment in which the subject desires to mitigate an outwardly detectable expression of either or both of a vocal tic and a physical tic,
or actuating the vibratory element preparatory to the imminent occurrence of one or more of:
introducing the subject to a stimulus objectively likely to induce one or more of a premonitory urge, a vocal tic and a physical tic,
the subject entering into an environment objectively likely to induce one or more of a premonitory urge, a vocal tic and a physical tic,
the subject entering an environment in which the subject desires to mitigate an outwardly detectable expression of either or both of a vocal tic and a physical tic.

12. The method of claim 11, wherein the vibratory structure further comprises:
an actuation control; and
either or both of a power source and an operable retainer for a power source.

13. A user-operable vibratory system suitably configured for discrete concealment within the structure of a selected head-wearable apparel item, comprising:
either or both of a battery and a retainer for a battery;
a first vibratory element;
a switch; and
one or more electrically conductive lines operably coupled with, and forming an electrical circuit including each of, the switch, the first vibratory element, and either or both of the battery and the operable retainer for a battery.

14. The system of claim 13, wherein one or more of the first vibratory element, the switch, and either or both of the battery and the retainer for a battery, include either or both of an adhesive and a fastener structure suitable to affect secure coupling with an interior surface of the selected head-wearable apparel item.

15. The system. of claim 13, wherein the first vibratory element is a coin cell vibratory motor.

16. The system of claim 13, wherein the selected head-wearable apparel item is one of a baseball-style cap, or a visor, or a mask.

17. The system of claim 13, wherein the retainer is configured as a receptacle suitable to receive insertion of, and to establish electrical contact with each of an anode and a cathode of a battery.

18. The system of claim 13, wherein either or both of the first vibratory element and the switch is suitably configured for concealment either between a sweatband and a crown of, or within a sweatband of, the selected head-wearable apparel item.

19. The system of claim 13, further comprising:
a second vibratory motor operably coupled via the one or more electrically conductive lines with each of the switch and either or both of the battery and the retainer for a battery.

20. The system of claim 19, wherein the second vibratory element is suitably configured for concealment either between a sweatband and a crown of, or within a sweatband of, the selected head-wearable apparel item.

21. The system of claim 19, wherein the second vibratory motor is configured for discrete concealment at a higher portion of a crown of the selected head-wearable apparel item than is the first vibratory motor.
